(19) United States
(12) Patent Application Publication
(10) Pub. No.: US 2016/0307562 A1
(43) Pub. Date: Oct. 20, 2016

(54) CONTROLLING SPEECH RECOGNITION SYSTEMS BASED ON RADIO STATION AVAILABILITY

(71) Applicant: GM Global Technology Operations LLC, Detroit, MI (US)

(72) Inventors: Xufang ZHAO, Windsor (CA); Gaurav TALWAR, Novi, MI (US); Joseph M. HUK, JR., Adrian, MI (US)

(21) Appl. No.: 14/686,053

(22) Filed: Apr. 14, 2015

(51) Int. Cl. G10L 15/065; G10L 15/26

(52) U.S. Cl. CPC G10L 15/065; G10L 15/265; G10L 2015/223

(57) ABSTRACT

A system and method of controlling an automatic speech recognition (ASR) system includes: determining the location of a vehicle; identifying terrestrial radio stations in a database that are within a range of the vehicle location based on geographic locations of the terrestrial radio stations stored in the database; and altering the content of a speech grammar used by the ASR system to process speech received in the vehicle that requests a terrestrial radio station.

### TECHNICAL FIELD

The present invention relates to speech recognition and, more particularly, to controlling speech recognition systems based on radio station availability.

### BACKGROUND

Vehicles often include automatic speech recognition (ASR) systems that can receive speech from a user or vehicle occupant and translate the speech into text. The speech can involve a wide variety of different topics posed by the user. It can be challenging for ASR systems to translate received speech given the variety of content the speech could include and do so accurately and quickly. The ASR systems may consult speech grammars that are prepared for this variety by including a large amount of data. But preparing ASR systems with large speech grammars can adversely affect both the speed at which the systems return a result and how accurate that result is once it is returned.

To reduce the size of the speech grammars or the scope within the grammars that is searched, ASR systems can benefit from having some indication of the context of the received speech. When the ASR system has advance knowledge of the user's subject, the ASR system can use that knowledge to detect words and phrases that are likely to occur during a conversation relating to the subject. For example, if the ASR system knows that the user is asking for navigational directions, the system can use a navigation-specific vocabulary to process speech from the user. The ASR system can then more quickly and accurately generate a hypothesis for the received speech.

However, in some ASR applications, knowing the context of the received speech may not reduce latency or increase accuracy of the ASR system. One example of this involves identifying radio stations in a vehicle via speech. Even if the ASR system is primed with the context of a user requesting a radio station, a vehicle could tune in a large number of possible radio stations as it moves—especially when factoring in-band on-channel radio stations, such as HD radio. A vehicle occupant could request any one of a large number of radio stations, which can involve a very large speech grammar to recognize these requests. Vehicles are configured to move throughout a large area, such as a country. So the speech grammar may be configured in a way that it can include data for every possible radio station in the country. Considering the number of possible radio stations a vehicle occupant could request as a vehicle moves, it would be helpful to selectively limit the speech grammar used to recognize spoken radio stations.

### SUMMARY

According to an embodiment of the invention, there is provided a method of controlling an automatic speech recognition (ASR) system. The method includes determining the location of a vehicle; identifying terrestrial radio stations in a database that are within a range of the vehicle location based on geographic locations of the terrestrial radio stations stored in the database; and altering the content of a speech grammar used by the ASR system to process speech received in the vehicle that requests a terrestrial radio station.

According to another embodiment of the invention, there is provided a method of controlling an ASR system. The method includes determining the location of a vehicle; defining an area surrounding the vehicle using a predetermined distance from the vehicle; finding in a database one or more terrestrial radio stations located within the defined area; identifying the names of the identified terrestrial radio station(s) to a speech grammar; and processing received speech in the vehicle using the speech grammar.

According to yet another embodiment of the invention, there is provided a method of controlling an ASR system. The method includes determining the location of a vehicle; defining an area surrounding the vehicle using a predetermined distance from the vehicle; finding in a database one or more terrestrial radio stations located within the defined area; assigning a probability value to each found terrestrial radio station based on location; identifying the names of the found terrestrial radio station(s) and assigned probability values to a speech grammar; and processing received speech in the vehicle using the speech grammar.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein; and

FIG. 2 is a block diagram depicting an embodiment of an automatic speech recognition (ASR) system;

FIG. 3 is a flow chart depicting one implementation of a method of controlling an ASR system; and

FIG. 4 depicts an implementation of a defined area surrounding a vehicle that can be used with the method of controlling an ASR system.

### DETAILED DESCRIPTION OF THE ILLUSTRATED EMBODIMENTS

The system and method described below modifies or limits a speech grammar used by an ASR system to identify terrestrial radio station names spoken in a vehicle. Vehicle occupants can control the selection of a terrestrial radio station using speech commands. As the vehicle moves, it may only be able to tune in a limited number of terrestrial radio stations at any one time based on the location of the vehicle. Despite this limitation, past speech grammars have been configured to recognize every possible radio station whose signal the vehicle could receive. Rather than preparing speech grammars for application to a wide variety of different terrestrial radio stations, the speech grammars can be dynamically tailored as the vehicle moves to recognize a limited number of terrestrial radio stations having a signal that the vehicle is capable of receiving.

A vehicle can maintain a database containing information about terrestrial radio stations in a geographic area, such as a country or a state. That information can include the location of each terrestrial radio station and, optionally, a broadcasting power level that indicates how far the radio station signal can reach. The vehicle can determine its location and compare it with terrestrial radio station information in the database. Using a predefined distance within which the vehicle can expect to receive terrestrial radio signals, the vehicle can identify a limited number of terrestrial radio stations. The speech grammar used by the ASR system can then be optimized to only consider, or more heavily weight, the limited number of terrestrial radio stations. This can limit the possible radio station identities that an ASR system will consider based on the location of the vehicle relative to the radio stations. As the vehicle moves, the vehicle can periodically update the speech grammar as it moves away from some terrestrial radio stations and toward others.

### Communications System—

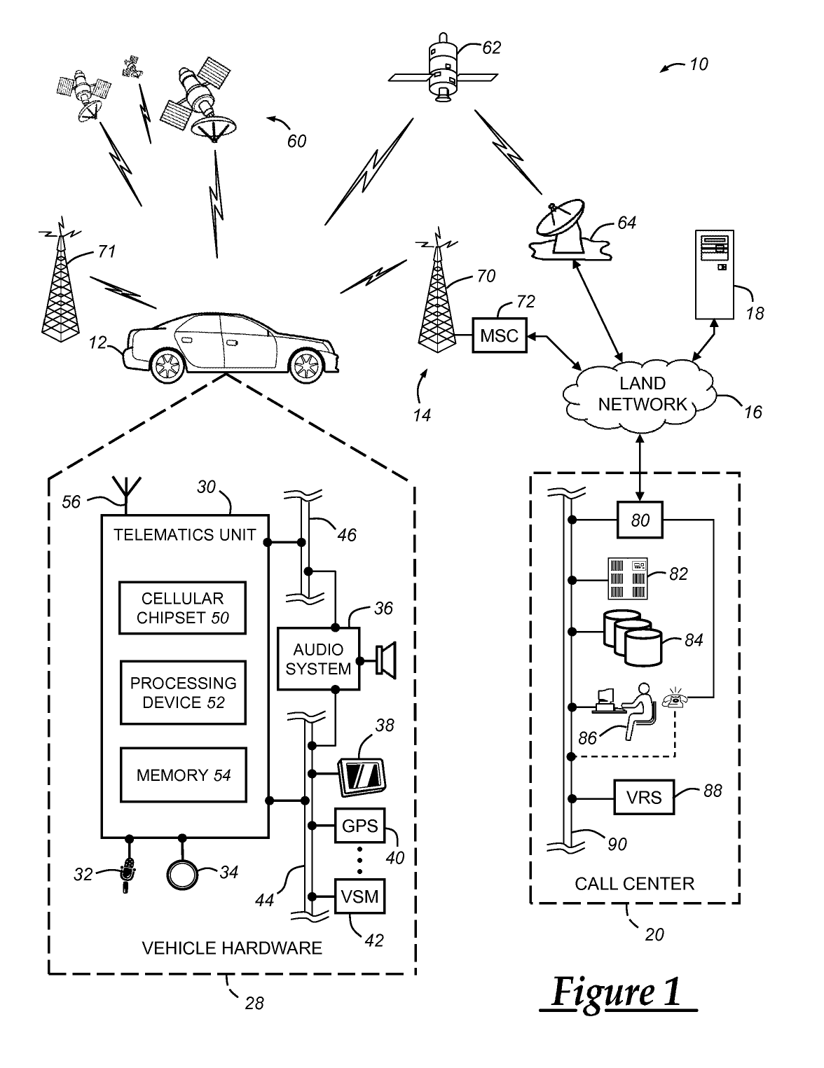

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM, CDMA, or LTE standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as LTE, EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, including short range wireless communication (SRWC) such as any of the IEEE 802.11 protocols, WiMAX, ZigBee™, Wi-Fi direct, Bluetooth, or near field communication (NFC). When used for packet-switched data communication such as TCP/IP, the telematics unit can be configured with a static IP address or can set up to automatically receive an assigned IP address from another device on the network such as a router or from a network address server.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. A terrestrial radio station 71 can broadcast radio programming to the audio system 36. Terrestrial radio stations, as they are used herein, refer to radio broadcasting entities using land-based transmitters to provide radio programming via analog radio broadcasts, such as AM and FM broadcasting, or digital radio broadcasts. Examples of digital radio broadcasting include DRM, DAB, and in-band on-channel radio service (e.g., HD radio). Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

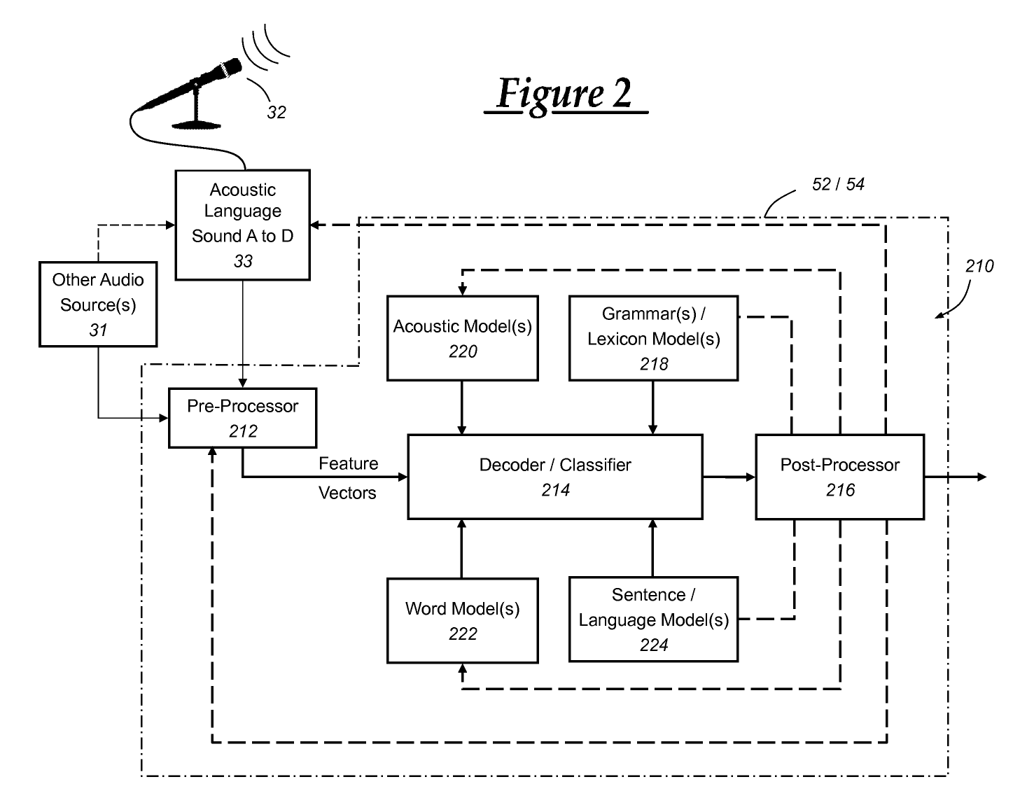

Turning now to FIG. 2, there is shown an illustrative architecture for an ASR system 210 that can be used to enable the presently disclosed method. In general, a vehicle occupant vocally interacts with an automatic speech recognition system (ASR) for one or more of the following fundamental purposes: training the system to understand a vehicle occupant's particular voice; storing discrete speech such as a spoken nametag or a spoken control word like a numeral or keyword; or recognizing the vehicle occupant's speech for any suitable purpose such as voice dialing, menu navigation, transcription, service requests, vehicle device or device function control, or the like. Generally, ASR extracts acoustic data from human speech, compares and contrasts the acoustic data to stored subword data, selects an appropriate subword which can be concatenated with other selected subwords, and outputs the concatenated subwords or words for post-processing such as dictation or transcription, address book dialing, storing to memory, training ASR models or adaptation parameters, or the like.

ASR systems are generally known to those skilled in the art, and FIG. 2 illustrates just one specific illustrative ASR system 210. The system 210 includes a device to receive speech such as the telematics microphone 32, and an acoustic interface 33 such as a sound card of the telematics unit 30 having an analog to digital converter to digitize the speech into acoustic data. The system 210 also includes a memory such as the telematics memory 54 for storing the acoustic data and storing speech recognition software and databases, and a processor such as the telematics processor 52 to process the acoustic data. The processor functions with the memory and in conjunction with the following modules: one or more front-end processors or pre-processor software modules 212 for parsing streams of the acoustic data of the speech into parametric representations such as acoustic features; one or more decoder software modules 214 for decoding the acoustic features to yield digital subword or word output data corresponding to the input speech utterances; and one or more post-processor software modules 216 for using the output data from the decoder module(s) 214 for any suitable purpose.

The system 210 can also receive speech from any other suitable audio source(s) 31, which can be directly communicated with the pre-processor software module(s) 212 as shown in solid line or indirectly communicated therewith via the acoustic interface 33. The audio source(s) 31 can include, for example, a telephonic source of audio such as a voice mail system, or other telephonic services of any kind.

One or more modules or models can be used as input to the decoder module(s) 214. First, grammar and/or lexicon model(s) 218 can provide rules governing which words can logically follow other words to form valid sentences. In a broad sense, a grammar can define a universe of vocabulary the system 210 expects at any given time in any given ASR mode. For example, if the system 210 is in a training mode for training commands, then the grammar model(s) 218 can include all commands known to and used by the system 210. In another example, if the system 210 is in a main menu mode, then the active grammar model(s) 218 can include all main menu commands expected by the system 210 such as call, dial, exit, delete, directory, or the like. Second, acoustic model(s) 220 assist with selection of most likely subwords or words corresponding to input from the pre-processor module(s) 212. Third, word model(s) 222 and sentence/language model(s) 224 provide rules, syntax, and/or semantics in placing the selected subwords or words into word or sentence context. Also, the sentence/language model(s) 224 can define a universe of sentences the system 210 expects at any given time in any given ASR mode, and/or can provide rules, etc., governing which sentences can logically follow other sentences to form valid extended speech.

According to an alternative illustrative embodiment, some or all of the ASR system 210 can be resident on, and processed using, computing equipment in a location remote from the vehicle 12 such as the call center 20. For example, grammar models, acoustic models, and the like can be stored in memory of one of the servers 82 and/or databases 84 in the call center 20 and communicated to the vehicle telematics unit 30 for in-vehicle speech processing. Similarly, speech recognition software can be processed using processors of one of the servers 82 in the call center 20. In other words, the ASR system 210 can be resident in the telematics unit 30, distributed across the call center 20 and the vehicle 12 in any desired manner, and/or resident at the call center 20.

First, acoustic data is extracted from human speech wherein a vehicle occupant speaks into the microphone 32, which converts the utterances into electrical signals and communicates such signals to the acoustic interface 33. A sound-responsive element in the microphone 32 captures the occupant's speech utterances as variations in air pressure and converts the utterances into corresponding variations of analog electrical signals such as direct current or voltage. The acoustic interface 33 receives the analog electrical signals, which are first sampled such that values of the analog signal are captured at discrete instants of time, and are then quantized such that the amplitudes of the analog signals are converted at each sampling instant into a continuous stream of digital speech data. In other words, the acoustic interface 33 converts the analog electrical signals into digital electronic signals. The digital data are binary bits which are buffered in the telematics memory 54 and then processed by the telematics processor 52 or can be processed as they are initially received by the processor 52 in real-time.

Second, the pre-processor module(s) 212 transforms the continuous stream of digital speech data into discrete sequences of acoustic parameters. More specifically, the processor 52 executes the pre-processor module(s) 212 to segment the digital speech data into overlapping phonetic or acoustic frames of, for example, 10-30 ms duration. The frames correspond to acoustic subwords such as syllables, demi-syllables, phones, diphones, phonemes, or the like. The pre-processor module(s) 212 also performs phonetic analysis to extract acoustic parameters from the occupant's speech such as time-varying feature vectors, from within each frame. Utterances within the occupant's speech can be represented as sequences of these feature vectors. For example, and as known to those skilled in the art, feature vectors can be extracted and can include, for example, vocal pitch, energy profiles, spectral attributes, and/or cepstral coefficients that can be obtained by performing Fourier transforms of the frames and decorrelating acoustic spectra using cosine transforms. Acoustic frames and corresponding parameters covering a particular duration of speech are concatenated into unknown test pattern of speech to be decoded.

Third, the processor executes the decoder module(s) 214 to process the incoming feature vectors of each test pattern. The decoder module(s) 214 is also known as a recognition engine or classifier, and uses stored known reference patterns of speech. Like the test patterns, the reference patterns are defined as a concatenation of related acoustic frames and corresponding parameters. The decoder module(s) 214 compares and contrasts the acoustic feature vectors of a subword test pattern to be recognized with stored subword reference patterns, assesses the magnitude of the differences or similarities therebetween, and ultimately uses decision logic to choose a best matching subword as the recognized subword. In general, the best matching subword is that which corresponds to the stored known reference pattern that has a minimum dissimilarity to, or highest probability of being, the test pattern as determined by any of various techniques known to those skilled in the art to analyze and recognize subwords. Such techniques can include dynamic time-warping classifiers, artificial intelligence techniques, neural networks, free phoneme recognizers, and/or probabilistic pattern matchers such as Hidden Markov Model (HMM) engines.

HMM engines are known to those skilled in the art for producing multiple speech recognition model hypotheses of acoustic input. The hypotheses are considered in ultimately identifying and selecting that recognition output which represents the most probable correct decoding of the acoustic input via feature analysis of the speech. More specifically, an HMM engine generates statistical models in the form of an “N-best” list of subword model hypotheses ranked according to HMM-calculated confidence values or probabilities of an observed sequence of acoustic data given one or another subword such as by the application of Bayes' Theorem.

A Bayesian HMM process identifies a best hypothesis corresponding to the most probable utterance or subword sequence for a given observation sequence of acoustic feature vectors, and its confidence values can depend on a variety of factors including acoustic signal-to-noise ratios associated with incoming acoustic data. The HMM can also include a statistical distribution called a mixture of diagonal Gaussians, which yields a likelihood score for each observed feature vector of each subword, which scores can be used to reorder the N-best list of hypotheses. The HMM engine can also identify and select a subword whose model likelihood score is highest.

In a similar manner, individual HMMs for a sequence of subwords can be concatenated to establish single or multiple word HMM. Thereafter, an N-best list of single or multiple word reference patterns and associated parameter values may be generated and further evaluated.

In one example, the speech recognition decoder 214 processes the feature vectors using the appropriate acoustic models, grammars, and algorithms to generate an N-best list of reference patterns. As used herein, the term reference patterns is interchangeable with models, waveforms, templates, rich signal models, exemplars, hypotheses, or other types of references. A reference pattern can include a series of feature vectors representative of one or more words or subwords and can be based on particular speakers, speaking styles, and audible environmental conditions. Those skilled in the art will recognize that reference patterns can be generated by suitable reference pattern training of the ASR system and stored in memory. Those skilled in the art will also recognize that stored reference patterns can be manipulated, wherein parameter values of the reference patterns are adapted based on differences in speech input signals between reference pattern training and actual use of the ASR system. For example, a set of reference patterns trained for one vehicle occupant or certain acoustic conditions can be adapted and saved as another set of reference patterns for a different vehicle occupant or different acoustic conditions, based on a limited amount of training data from the different vehicle occupant or the different acoustic conditions. In other words, the reference patterns are not necessarily fixed and can be adjusted during speech recognition.

Using the in-vocabulary grammar and any suitable decoder algorithm(s) and acoustic model(s), the processor accesses from memory several reference patterns interpretive of the test pattern. For example, the processor can generate, and store to memory, a list of N-best vocabulary results or reference patterns, along with corresponding parameter values. Illustrative parameter values can include confidence scores of each reference pattern in the N-best list of vocabulary and associated segment durations, likelihood scores, signal-to-noise ratio (SNR) values, and/or the like. The N-best list of vocabulary can be ordered by descending magnitude of the parameter value(s). For example, the vocabulary reference pattern with the highest confidence score is the first best reference pattern, and so on. Once a string of recognized subwords are established, they can be used to construct words with input from the word models 222 and to construct sentences with the input from the language models 224.

Finally, the post-processor software module(s) 216 receives the output data from the decoder module(s) 214 for any suitable purpose. In one example, the post-processor software module(s) 216 can identify or select one of the reference patterns from the N-best list of single or multiple word reference patterns as recognized speech. In another example, the post-processor module(s) 216 can be used to convert acoustic data into text or digits for use with other aspects of the ASR system or other vehicle systems. In a further example, the post-processor module(s) 216 can be used to provide training feedback to the decoder 214 or pre-processor 212. More specifically, the post-processor 216 can be used to train acoustic models for the decoder module(s) 214, or to train adaptation parameters for the pre-processor module(s) 212.

The method or parts thereof can be implemented in a computer program product embodied in a computer readable medium and including instructions usable by one or more processors of one or more computers of one or more systems to cause the system(s) to implement one or more of the method steps. The computer program product may include one or more software programs comprised of program instructions in source code, object code, executable code or other formats; one or more firmware programs; or hardware description language (HDL) files; and any program related data. The data may include data structures, look-up tables, or data in any other suitable format. The program instructions may include program modules, routines, programs, objects, components, and/or the like. The computer program can be executed on one computer or on multiple computers in communication with one another.

The program(s) can be embodied on computer readable media, which can be non-transitory and can include one or more storage devices, articles of manufacture, or the like. Exemplary computer readable media include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium may also include computer to computer connections, for example, when data is transferred or provided over a network or another communications connection (either wired, wireless, or a combination thereof). Any combination(s) of the above examples is also included within the scope of the computer-readable media. It is therefore to be understood that the method can be at least partially performed by any electronic articles and/or devices capable of carrying out instructions corresponding to one or more steps of the disclosed method.

### Method—

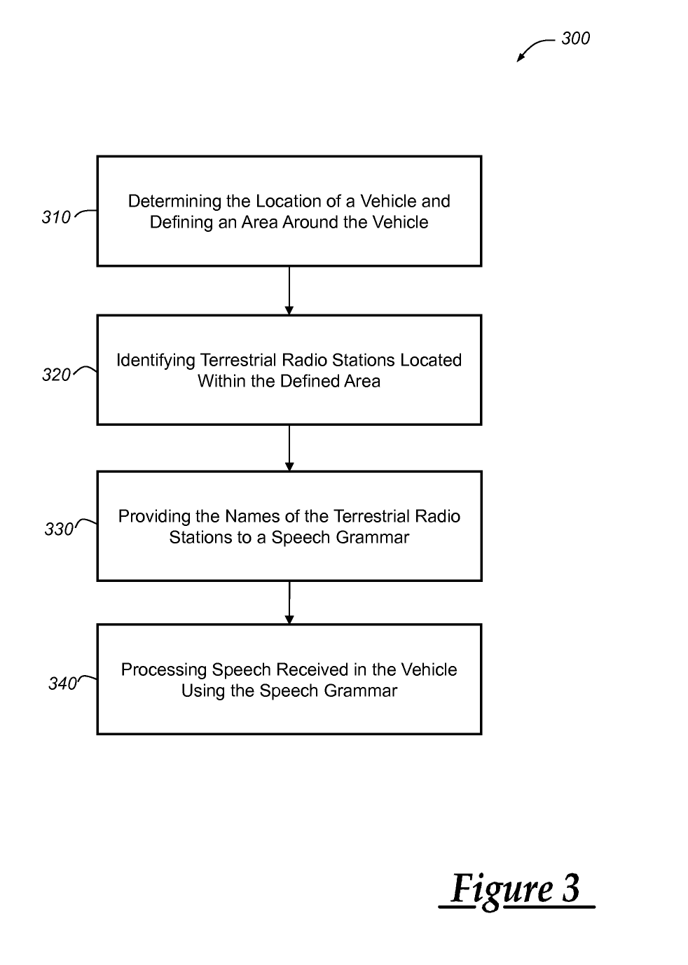

Referring to FIGS. 1-3, there is shown an embodiment of a method 300 of controlling the ASR system 210. The method 300 begins at step 310 by determining the location of the vehicle 12 and defining an area surrounding the vehicle 12 using a predetermined distance from the vehicle 12. The location of the vehicle 12 can be determined in many suitable ways. For example, the GPS module 40 can receive signals from GPS satellites and identify the present location of the vehicle 12 using these signals. The location can be determined by the GPS module 40 in a latitude and longitude format and provided to the vehicle telematics unit 30 via the vehicle communications bus 44.

The vehicle telematics unit 30 can access the memory device 54 and retrieve a predetermined distance value for defining the area around the vehicle 12. Using the location of the vehicle 12 as an origin or center point of the area, the predetermined distance value can be used to determine how far away from the vehicle 12 the area can extend. The distance value can be established based on the possible or theoretical range of terrestrial radio stations 71 nearby the vehicle 12. In one implementation, the distance value can be based on the longest theoretical distance the vehicle 12 could expect to receive radio signals from a terrestrial radio station 71. That way, the area surrounding the vehicle 12 can include all terrestrial radio stations that the vehicle 12 could expect to be capable of receiving signals from. For instance, a commercial terrestrial radio station 71 broadcasting at a power level of 50 KW can propagate about 30-50 miles from the transmitter. In a given metropolitan area it may be possible to receive approximately 30 FM radio facilities (87.9-107.9 MHz) with a good quality signal strength. In the AM broadcast band (530-1710 KHz), it may be possible to receive 30 to 40 radio facilities, with reasonable quality, during the day. Given the 30-50 mile range, it is possible to set the distance value to 50 miles. However, the quality and characteristics of radio signal reception can change depending on the time of day as well as the different power levels at which terrestrial radio stations broadcast. In view of this, the predetermined distance can be implemented using different values and even can be remotely changed from the call center 20 or other central facility, if needed. The method 300 proceeds to step 320.

At step 320, one or more terrestrial radio stations located within the defined area are identified in a database. The vehicle 12 can access a database including the name or identity of each terrestrial radio station located in the area (e.g., country) in which the vehicle 12 will operate. Depending on the area where the vehicle 12 is sold or intended to operate, the database can be configured to include each known terrestrial radio station name—including in-band on-channel service channels or stations—that broadcasts in the that area. For example, if the vehicle 12 is intended to be sold or operated in the United States, the database can be configured to include the name of every known terrestrial radio station that broadcasts in the U.S. Along with the radio station name, a geographic location can be stored that indicates the location of the radio transmitter for the terrestrial radio station. The geographic location can be a latitude and longitude coordinate pair that can be compared with the vehicle location to determine whether or not the terrestrial radio station is within the defined area or predetermined distance from the vehicle 12. The database can then be maintained at the vehicle 12, such as in the memory device 54 or it could be stored at a central facility, such as the computer 18 or call center 20 where it can be wirelessly accessed by the vehicle 12 via the wireless communication system 14.

In some embodiments, additional information beyond a radio station name and a location of its transmitter can be stored in the database. For example, each terrestrial radio station can be identified not only by its name and location but also by a power level of the transmitter used to broadcast its radio programming. This can be helpful because not all terrestrial radio stations broadcast radio programming using the same transmitter power. Those stations using higher-powered transmitters can reach vehicles 12 further away than those with relatively lower-powered transmitters. By associating a power level of the transmitter for each terrestrial radio station, it is possible to include or exclude a station from the defined area based not only on its location relative to the vehicle 12, but also on an ability of its signal to reach the vehicle 12.

In one example of how this could be implemented, the vehicle telematics unit 30 can determine its location and search the database for terrestrial radio stations that are within the defined area of 50 miles of the vehicle 12. Some of the terrestrial radio stations may be determined to be within a section or band 40-50 miles away from the vehicle 12. The vehicle telematics unit 30 can then access the broadcast power level of those terrestrial radio stations that are within the section and exclude those that may not broadcast at a power level sufficient to reach the vehicle 12. Examples of power levels capable of reaching the vehicle 12 could be wattages that are greater than 50 KW whereas radio transmitters broadcasting below 50 KW could be determined to be incapable of transmitting a signal to the vehicle 12. That is, a group of terrestrial radio stations can be initially identified as being within the defined area and then a subset of terrestrial radio stations originally included in that group can be removed based on the power level at which they broadcast radio programming coupled with their location—in this example, <50 KW.

Other variations of the method 300 are also possible. For instance, the defined area can be more particularly divided into sections or bands based on distance from the vehicle 12. Terrestrial radio stations located in bands that are nearer the vehicle 12 can be assigned a greater probability or weight than those stations that are located further away from the vehicle 12. Probability can refer to the likelihood a vehicle occupant will request a particular terrestrial radio station. Stations that are nearer the vehicle 12 are generally more-frequently requested than stations 71 located further away. So the name of each terrestrial radio station can be associated with a probability or likelihood that someone will request it. The probabilities can then be assigned to the names of the terrestrial radio stations included in the defined area and provided to the speech grammar.

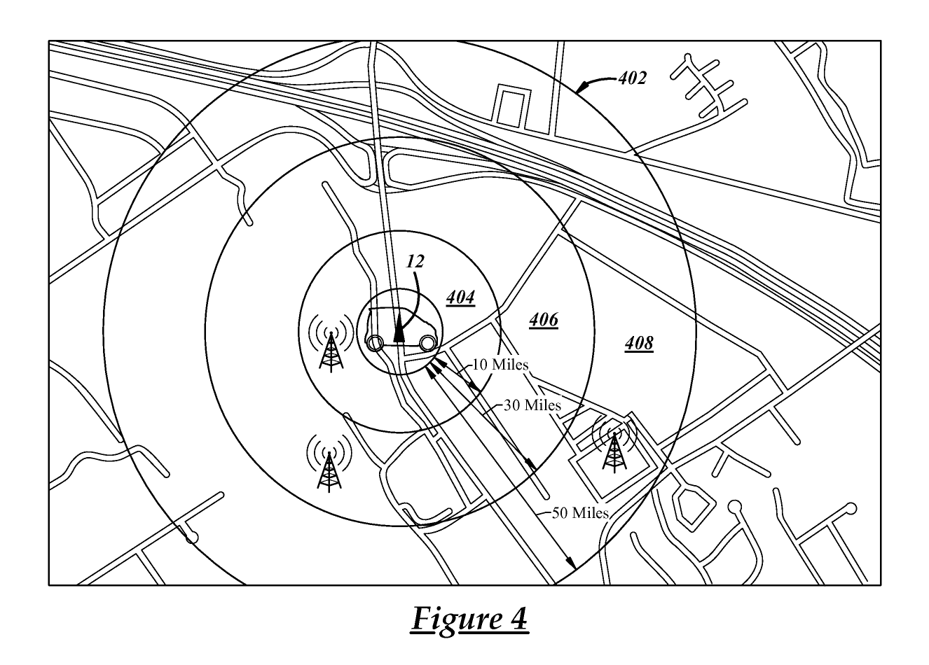

An example of the defined area as it can be divided into bands is shown in FIG. 4. There the vehicle 12 is located approximately in the center of a defined area 402. The defined area 402 in this example is bounded by a range of 50 miles and divided into three bands: an inner band 404, a middle band 406, and an outer band 408. The inner band 404 includes terrestrial radio stations 71 nearest the vehicle 12 and has an outer boundary of 10 miles. Terrestrial radio stations found in the inner band 404 may be the most likely to be requested by a vehicle occupant; a heavier weight or larger probability can be assigned to these stations 71 and these weights/probabilities can be used by a speech grammar to recognize speech requests for terrestrial radio stations in the vehicle 12. Furthest from the vehicle 12 is the outer band 408 located between 30-50 miles from the vehicle 12. Terrestrial radio stations 71 in the outer band 408 are less likely to be requested than the stations 71 found in the inner band 404. Therefore, a lower weight or probability can be assigned to the names of terrestrial radio stations 71 found in the outer band 408. The middle band 406 is located in between the inner band 404 and the outer band 408 existing between 10-30 miles from the vehicle 12. Terrestrial radio stations 71 found in the middle band 406 can be assigned a probability or weight that is higher than those in the outer band 408 but lower than stations 71 found in the inner band 404. The method 300 proceeds to step 330.

At step 330, the names of the identified terrestrial radio stations 71 are provided to a speech grammar. The ASR system 210 can receive the terrestrial radio station names and then limit or modify a speech grammar used to receive radio station requests via speech. After receiving the terrestrial radio station names, the ASR system 210 can tag each word or name among the received radio station names and then provide those tagged names to the grammar models 218 used by the system 210. By tagging or otherwise identifying the received radio station names, the ASR system 210 may be able to load or use a subset of a larger grammar that includes or more-heavily weights the names of the identified radio stations. As discussed above, in some implementations the ASR system 210 can attribute weights or probability values to the name of each terrestrial radio station in the grammar that is based on distance from the vehicle 12. When the ASR system 210 uses a speech grammar including the probability values, it can create a bias toward terrestrial radio stations that are nearer to the vehicle 12. Steps 310-330 can be repeated periodically so that as the vehicle 12 moves, a current list of terrestrial radio stations can be maintained for use by the ASR system 210. The method 300 proceeds to step 340.

At step 340, received speech is processed in the vehicle 12 using the speech grammar that has been limited or modified using the name(s) of terrestrial radio stations. When a vehicle occupant requests that the vehicle 12 tune in a terrestrial radio station 71, speech can be received via the microphone 32, converted to a digital signal at the AD converter of the acoustic interface 33, and then parsed into feature vectors by the pre-processor 212. The feature vectors can then be processed using the updated grammar described above with regard to steps 310-330. The method 300 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of controlling an automatic speech recognition (ASR) system, comprising the steps of:
(a) determining the location of a vehicle;
(b) identifying terrestrial radio stations in a database that are within a range of the vehicle location based on geographic locations of the terrestrial radio stations stored in the database; and
(c) altering the content of a speech grammar used by the ASR system to process speech received in the vehicle that requests a terrestrial radio station.

2. The method of claim 1, further comprising the step of determining the power values of identified terrestrial radio stations.

3. The method of claim 1, wherein step (c) further comprises limiting the content of the speech grammar based on the names of the identified terrestrial radio stations.

4. The method of claim 1, wherein step (c) further comprises assigning a probability value to each name of the identified terrestrial radio stations.

5. The method of claim 1, further comprising the step of dividing the range into a plurality of bands that are classified according to distance from the vehicle.

6. The method of claim 5, further comprising the step of assigning a probability value to each band.

7. The method of claim 5, further comprising the step of limiting the number of identified terrestrial radio stations in at least one of the bands according to a broadcast power level.

8. The method of claim 1, wherein the database is located at the vehicle.

9. A method of controlling an automatic speech recognition (ASR) system, comprising the steps of:
(a) determining the location of a vehicle;
(b) defining an area surrounding the vehicle using a predetermined distance from the vehicle;
(c) finding in a database one or more terrestrial radio stations located within the defined area;
(d) identifying the names of the identified terrestrial radio station(s) to a speech grammar; and
(e) processing received speech in the vehicle using the speech grammar.

10. The method of claim 9, further comprising the step of determining the power values of the terrestrial radio stations found in the database.

11. The method of claim 9, further comprising the step of limiting the content of the speech grammar based on the names of the identified terrestrial radio stations.

12. The method of claim 9, further comprising the step of assigning a probability value to each name of the identified terrestrial radio stations.

13. The method of claim 9, further comprising the step of dividing the area into a plurality of bands that are classified according to distance from the vehicle.

14. The method of claim 13, further comprising the step of assigning a probability value to each band.

15. The method of claim 13, further comprising the step of limiting the number of identified terrestrial radio stations in at least one of the bands according to a broadcast power level.

16. A method of controlling an automatic speech recognition (ASR) system, comprising the steps of:
(a) determining the location of a vehicle;
(b) defining an area surrounding the vehicle using a predetermined distance from the vehicle;
(c) finding in a database one or more terrestrial radio stations located within the defined area;
(d) assigning a probability value to each found terrestrial radio station based on location;
(e) identifying the names of the found terrestrial radio station(s) and assigned probability values to a speech grammar; and
(f) processing received speech in the vehicle using the speech grammar.

17. The method of claim 16, further comprising the step of identifying terrestrial radio stations that are within the defined area based on radio station power values that are stored in the database.

18. The method of claim 16, further comprising the step of dividing the area into a plurality of bands that are classified according to distance from the vehicle.

19. The method of claim 18, further comprising the step of assigning a probability value to each band.

20. The method of claim 18, further comprising the step of limiting the number of identified terrestrial radio stations in at least one of the bands according to a broadcast power level.
